(19) United States
(12) Patent Application Publication
(10) Pub. No.: US 2020/0368614 A1
(43) Pub. Date: Nov. 26, 2020

(54) A system for acting on an online service among several users

(71) Applicants: Matti Vilola, Raisio (FI); Marko Haapala, Kruunupyy (FI)

(72) Inventors: Matti Vilola, Raisio (FI); Marko Haapala, Kruunupyy (FI); Tero Mukkula, Tabasalu (EE); Panu Mäki, Tuusula (FI)

(73) Assignees: Matti Vilola, Raisio (FI); Marko Haapala, Kruunupyy (FI)

(21) Appl. No.: 16/767,621

(22) PCT Filed: Nov. 29, 2018
(86) PCT No.: PCT/FI2018/050861

§ 371 Date: May 28, 2020

Related U.S. Application Data
(60) Provisional application No. 62/592,055, filed on Nov. 29, 2017.

(51) Int. Cl. A63F 13/358; H04L 29/06; A63F 13/352

(52) U.S. Cl. CPC A63F 13/358; A63F 13/352; H04L 67/38

(57) ABSTRACT

An inventive system for acting on an online service among several users, comprises a user application for each user, a server application and a database. The system is configured to provide information and statistic to each user application from the server application, and has an arrangement to treat all users equal with respect to server response time and network performance despite a physical location of each user application. In other words, the system enables fair service, like playing, despite of the player's geographical location.

### FIELD OF TECHNOLOGY

The invention relates to a system for acting on an online service among several users. Especially the invention relates a system playing a game online among several players. Online services, comprising online games, utilize communication networks, like mobile networks, internet, fixed network etc.

### PRIOR ART

Nowadays a great number of services are provided thought communication networks from a service provider to a user. The service is, for example, located to a server that is in connection with the communication network. The user that uses a user device like a mobile phone or a laptop can make requests for the service. Online games are examples of the services provided for the user, in these cases for the players.

A usual online game provides a video game that several players play from different locations. In order that the playing experience is reasonable for all players the video game has been designed to have some delays with respect to actions made by the players or the game itself. The designed delays can, for example, be 10-20 ms. In this way the players having different communication connections to the video game server could play the same game together with reasonable experience for everyone. However, if the player has a very slow communication connection with respect to the communication connections of the other player, the player with slow connection is in fact not in the same line with the other players when playing the game. Currently the online games and other online services can take latencies of the communication connections and other communication performances into account roughly or not at all.

### SHORT DESCRIPTION

The object of the invention is to alleviate or even eliminate the problems said above. The object is achieved in a way described in the independent claims. Dependent claims illustrate different embodiments of the invention.

An inventive system for acting on an online service among several users, comprises a user application for each user, a server application and a database. The system is configured to provide information and statistic to each user application from the server application, and has an arrangement to treat all users equal with respect to server response time and network performance despite a physical location of each user application. In other words, the system enables fair service, like playing, despite of the player's geographical location.

The arrangement in the server application is arranged to receive a request from any of the user applications, to record a high resolution time for the request, to calculate a fair time for the user application, to create a response to the request based on the fair time taking into account the high resolution time, and to send the response to the user application.

### LIST OF FIGURES

In the following, the invention is described in more detail by reference to the enclosed drawings, where

FIG. 1 illustrates an example of a visual representation of the simplified game screen for an inventive game,

FIG. 2 illustrates an example of a game progress,

FIG. 3 illustrates an example of a communication network architecture of the invention,

FIG. 4 illustrates an example how to make connection between the user application and the server application,

FIG. 5 illustrates a sequential flow of data in the connections,

FIG. 6 illustrates an example of a distributed infrastructure,

FIG. 7 illustrates an example of a fair time,

FIG. 8 illustrates an example of the method according to the invention,

FIG. 9 illustrates an example of the method according to the invention in more detail.

### DESCRIPTION OF THE INVENTION

An inventive system for acting on an online service among several users comprises a user application for each user, a server application (a centralized server application) and a database. The system is configured to provide information and statistic to each user application from the server application, and which system has an arrangement to treat all users equal with respect to server response time and network performance despite a physical location of each user application. As said above the online service utilizes communication networks, so the user application can be in connection with the server application via a communication network. The database can be in connection with the server application, also via a communication network if it is located at different place than the server application. The user application is in a user device like a mobile phone. The server application is in a server of the service provider.

The arrangement in the server application is arranged to receive a request from any of the user applications, to record a high resolution time for the request, to calculate a fair time for the user application, to create a response to the request based on the fair time taking into account the high resolution time, and to send the response to the user application.

The calculation of the fair time takes into account a physical distance between the user application and the server application, global trends based on distributed denial of service attacks, and latency time between the user application and the server application. The latency time can be based on a time of a day. Further, the latency time can be based on the day of a week.

In addition, the system can comprise at least one other server application. The other server application is between any of the user applications and the server application. The other service application can be a load balancer and it can be arranged to record a high resolution time for the request of the user application, to forward the request containing the high resolution time to the server application. The arrangement in the server is arranged to receive a request from any of the user applications via the other server application/load balancer. When using a load balancer/s the calculation of the fair time takes into account a physical distance between the user application and the other server application, a physical distance between the other server application and the server application, global trends based on distributed denial of service attacks between the user application and the other server application, global trends based on distributed denial of service attacks between the other server application and the server application, and latency time between the user application and the other server application, and the latency time between the other server application and the server application. The arrangement is arranged to send the response to the user application via the other server application.

The system can also comprise more than one server application, in which case each server application is located in separate servers, and the arrangement is arranged to make a connection between one of the client application and one of the server application in such a way that a connection performance value is calculated to each server application and an average connection performance value, and the server application having the connection performance value closest to the average value is selected to be the server application for the connection. In this way the system is scalable to an increasing demand of the service. In addition, at least one hot cache between the server application and the database can be provided which also increases scalability of the system and also helps to achieve a real time features of the service.

The server application can comprise an adaptive artificial intelligence logic to provide said fair time calculation. The artificial intelligence logic can be arranged to detect an automated program, ie. software robot, that sends the requests.

The system can be for playing an online game among said several users, the users being players of the online game, and the system is configured to provide information and statistic to each player to increase probability for winning the game, and which system has an arrangement to treat all players equal with respect to server response time and network performance despite a physical location of each player. The user application is in a user device, and can be arranged to provide said information and statistic, a number of requests of the online game and a request button on a display of the user device in a game that is described more below.

The invention relates also to a method for acting on an online service among several users, which service utilizes a user application for each user, a server application and a database. FIG. 8 illustrates the method according to the invention. The method comprises steps to provide 81 information and statistic to each user application from the server application, and to treat 82 all users equal with respect to server response time and network performance despite a physical location of each user application.

FIG. 9 illustrates the method in a more detail manner. The method comprises steps to be run in the server application, which steps comprise a step to 91 receive a request from any of the user applications, a step to record 92 a high resolution time for the request, a step to calculate 93 a fair time for the user application, a step to create 94 a response to the request based on the fair time taking into account the high resolution time, and a step to send 95 the response to the user application. These steps belong to the main steps of FIG. 8.

The calculation step of the fair time takes into account a physical distance between the user application and the server application, global trends based on distributed denial of service attacks, and latency time between the user application and the server application. The latency time can be based on a time of a day. In addition, the latency time can further be based on the day of a week.

When the service further utilizes at least one other server application, which other server application is between any of the user applications and the server application, the method is arranged to record a high resolution time for the request of the user application in said other server application, to forward the request containing the high resolution time to the server application. In the server application the method is arranged to receive a request from any of the user applications via the other server application, and in which method the calculation of the fair time takes into account a physical distance between the user application and the other server application, a physical distance between the other server application and the server application, i.e. the centralized server application, global trends based on distributed denial of service attacks between the user application and the other server application, global trends based on distributed denial of service attacks between the other server application and the server application, and latency time between the user application and the other server application, and the latency time between the other server application and the server application. Further, the method is arranged to send the response to the user application via the other server application.

The method can be arranged to make a connection between one of the user application and one of the server application in such a way that a connection performance value is calculated to each server application and an average connection performance value, and the server application having the connection performance value closest to the average value is selected to be the server application for the connection. Further, the method can be arranged to detect an automated program i.e. a software robot that sends the requests.

The method can be for playing an online game among said several users, the users being players of the online game, and the system is configured to provide information and statistic to each player to increase probability for winning the game, and which system has an arrangement to treat all players equal with respect to server response time and network performance despite a physical location of each player. So, the method can be arranged to provide said information and statistic, a number of requests of the online game and a request button on a display of a user device.

Now, the invention is described by using a online game as an example for illustrating the invention. This inventive online game provides a unique skill-based gaming experience. The game is played with a single click based on visual indicators which reveal the game progress for short periods of time. The game can be used both in mobile and in web environments collecting information on the usage patterns and incorporating intelligent algorithms for game experience and game fairness enhancement. The game is related to the web and mobile based application. In this description the game can be called “ClickJackpot”.

The game is made for gambling and our unique inventions enable people to win some of the highest prices that are comparable to any casino games or lotteries as of today. Our game will be available worldwide, and it will be played with both with the crypto-currency tokens and with different other currencies, such as EUR.

The game provides unique simple click-based gambling experience. It is skill-based gambling game and more accessible to casual players than Poker is: easier to play, always available without time constraints, fun and engaging, and very much rewarding with a higher grand price than that of any existing grand lotteries, such as EuroJackpot or EuroMillions that are pure random-number-generator (RNG) lotteries.

The multi-step rewards program allows players to win instant prices with every single play session along the way to the grand jackpot.

The game is played with a single click using various information and statistics to increase their probability for the winnings.

Players play against other players online and just with a click of a button. The gambling can be done at any time, on any device, with average playing round lasting less than a minute. For increased rewards, more time is required to play. Active players are rewarded regularly. The use of game metrics allows skill-based gaming and playing smarter than others.

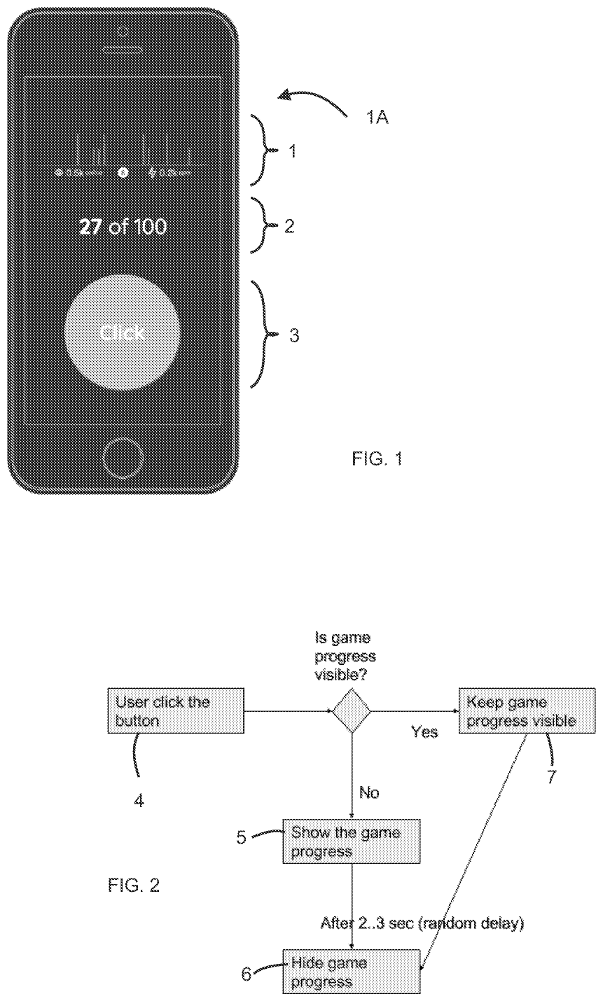

A visual representation of the simplified game screen is shown in FIG. 1. The screen consists of following main elements:
Visual indicators 1 show game statistics and other information. The indicators can show who has won and which level prices;
Number of clicks per 100 i.e. a number indicator 2 which is shown for approximately 2.3 seconds after each click. This indicator indicates which click it was out of 100. Every 100th click wins so the player has to try to get the 100th click; and
Button 3 to click to play.

The illustration of the game screen in FIG. 1 indicates one of the possible forms of the user interface, like a mobile phone 1A. It can be regarded as a simple example of the realization of the game. Another version may include more advanced graphical illustrations of the game statistics and the user feedback. There may be additional buttons with functionalities which improve the game experience, the game rewards, the social aspect of the game, or the chance to win the game.

So, the user clicks to play. Every 100th click wins (note: also other clicks may be set to win). The other online players try to get 100^{th} click (or whichever is said to be the winning click or clicks). The player can utilize visual indicators, game statistics and metrics, such as CPM (clicks per minute) and other metrics to click smarter than others, to guess the 100th click, to win against other players.

For each successive click, the actual progress of the game is revealed, and the user experience is made increasingly tense. Using this cumulative information, revealed by the game, the user is able to use his/her skills to win.

Each click consumes credit/bet from the user. The bet is allocated for multi-step rewards program, e.g. 50% of the bet will go to the 100th click winnings continuously (note: the % allocated depends on the setup of the game). Rest of the allocation is dynamic and adapted based on multiple unique technical factors including (but not limited to) the user behavior on the game, the system performance and functionality, the ongoing and short-term total gaming activity as well as the utilization of various external sources and online factors.

Artificial intelligence is used to determine network routing in the infrastructure, and logic, to treat all users equal with as close to another in server response time and network performance. The application works together with the infrastructure (servers, load balancers, cache, network) in order to determine the equalized connection for the user as similar to other users online at the same time and based on global average metrics. This will make all users treated the same no matter where they are physically. For the game this mechanism is used to implement a “global fair play” connection mechanism: instead of having a close physical proximity to the backend server, the AI will guarantee that you will never have one.

The game is simple, click-based, gambling game. The user interface is simple, and game is dependent on visual indicators and single action behavior (click). The visual indicators are based on one-to-many user interface components that show the game metrics and statistics to the user/player. These components include many visual components such as “heart”, “pulse”, “line-bar” graph that is moving over time, numbers, icons and acronyms. The visual indicators 1 indicate following type of information:
Number of people online: number, icon
Number of clicks per minute: number, icon, pulse, “line-bar” graph, “pulsating heart”
Indication of jackpot reward size: icon, number or character
Server status and speed: icon, number
In addition, real-time/actual status of the game 2, i.e. number of clicks per 100 number can be showed.

A simplified flow of the game flow is shown in FIG. 2. In order that the game is thrilling the game progress is showed 5 to the player during a short period, like 2-3 seconds after the click of the button 4 on the users device. After the period the game process is hidden 6. If the game progress is already showed on the display of the user device when clicking the button 3, it is kept visible 7.

The flow of the game is controlled by algorithms which enhance and optimize the game experience. The information/data for the visual indicators is sent from the backend to the client with a specific protocol that we have developed and innovated using websockets and similar technology with broadcasting/multicasting channeling. The WebSocket is a protocol that enables interaction between a user device, like browser, and a server. The protocol facilitates real-time data transfer from and to the server. The protocol can provide a two-way ongoing communication between the user and the server. The visual indications are provided for the user using the client application, either using web or mobile channels, e.g. web app, mobile app. This application is implemented using responsive/adaptive technologies that work both in desktop computers and on mobile/tablet devices.

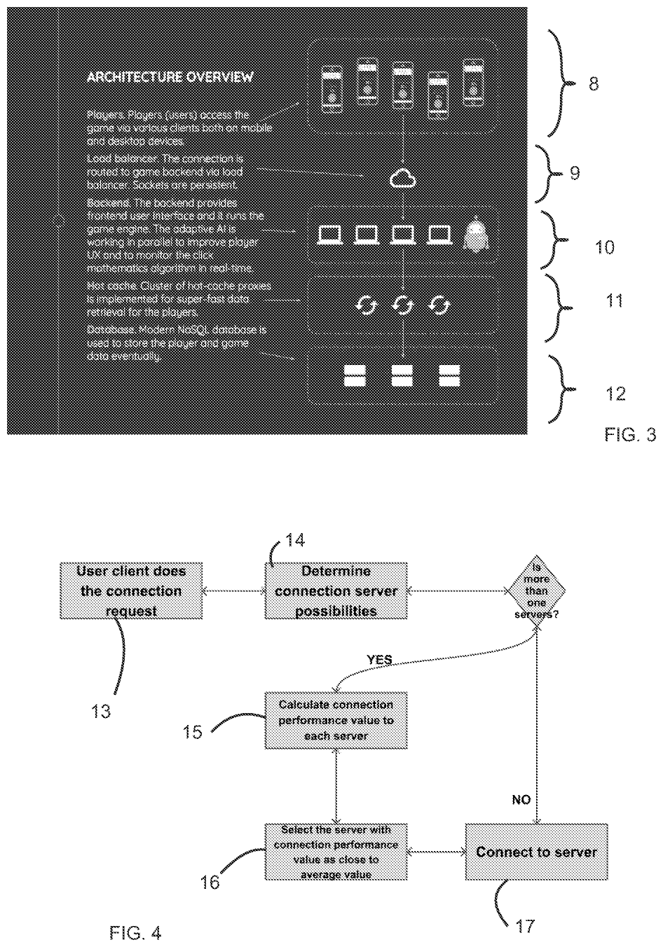

The client application communicates with the distributed server architecture using multiple layers of communication: hot cache for superior response time and with artificial intelligence (AI) for fair play connections that distributes the data for persistent actions and storage without real-time requirements. See FIG. 3 for an overview of the multi-layer connection architecture. Player have their devices with said user applications 8. The user applications can be connected through the other server application/s 9, i.e. the load balancer/s to the server/s having the already said server application/s 10. The load balancer is a server that can select the server to which a user request is connected. Different load balancing algorithms can be used. See FIG. 4. The server application/s is in connection with the database 12, which connection is convenient to provide via a hot cache/s 11 as showed in FIG. 3. The hot caches are memories having copies of some persistent data of the database, which makes providing service faster.

The application works together with the infrastructure (servers, load balancers, cache, network) in order to determine the equalized connection for the user as similar to other users online at the same time and based on global average metrics. This will make all users treated the same no matter where they are physically.

FIG. 4 shows an example how to connect the user application (user client) to the server having the server application. The user requests for the connection 13. A connection server possibilities are determined 14, for example in a load balancer (FIG. 3). In case of having several servers, a connection performance value to each server is calculated 15. The server/server application having the connection performance value closest to the average value is selected 16 to be a server whereto the user application is connected. In this way user application having similar or close connection performance values are connected 17 to the same server.

The “connection performance value” is a mixture of server connection parameters: latency and bandwidth. The connection logic glossary for terms used in this description is explained in Table. 1.

TABLE 1

| | |
|---|---|
| User | A system user. |
| CPS | Close Proximity Server. The server closest to the User. |
| HRT | High Resolution Time. The smallest unit of time that is |
| | supported by the infrastructure. |
| IP | Internet Protocol. |
| AI | Artificial Intelligence. |
| MS | Main Server. The part where all of the data gathered is |
| | eventually received and processed. |
| DDoS | Distributed Denial of Service attack. |
| Node | A server on the Internet. |
| Time of Day | UTC adjusted to the daytime of a Time Zone. |
| Day of the | Monday, Tuesday, Wednesday, Thursday, Friday, Saturday |
| Week | and Sunday |
| Time Zone | A geographical standard where the same time is used. |
| Fair Time | A timestamp that is fair for global time of execution. |
| | Calculated using variables between the User and the MS. |
| | May be positive or negative relative to the User's local time |
| | based on the variables between the User and the MS. |
| Request | A RFC 2616 Request. |
| Response | A RFC 2616 Response. |
| Latency | The time taken for two Nodes on the Internet to |
| | communicate in one way. |

An example on how the calculations in the connection logic could be implemented is shown in List. 1.
1. The CPS of the User receives the User's Request.
2. The CPS records the HRT of when it received the User Request, along with the User's IP address.
3. The CPS forwards the Request containing the HRT and User IP address to the MS.
4. The MS receives the Request.
5. The MS AI calculates and adapts a Fair Time for the User based on:
   5.1 Physical distance from the User to the CPS.
   5.2 Physical distance from the CPS to the MS.
   5.3 Global trends based on DDoS attacks that may slow down the infrastructure
   between the User and CPS.
   5.4 Global trends based on DDoS attacks that may slow down the infrastructure
   between the CPS and MS.
   5.6 The estimated Latency between the User and the CPS based on the Time of Day.
   5.7 The estimated Latency between the CPS and MS based on the Time of Day.
   5.6 The estimated Latency between the User and the CPS based on the Day of the Week.
   5.7 The estimated Latency between the CPS and MS based on the Day of the Week.
   (5.8 The performance of the client apparatus)
6. The MS creates a Response based on Fair Time.
7. The MS sends the Response to the CPS.
8. The CPS delegates the MS Response to the User.

List 1. Example of the Calculations in the Connection Logic Flow

The example of the list 1 has the server application/load balancer that is called as CPS. Note that example comprises an optional phase 5.8. to take into account the performance of the client apparatus.

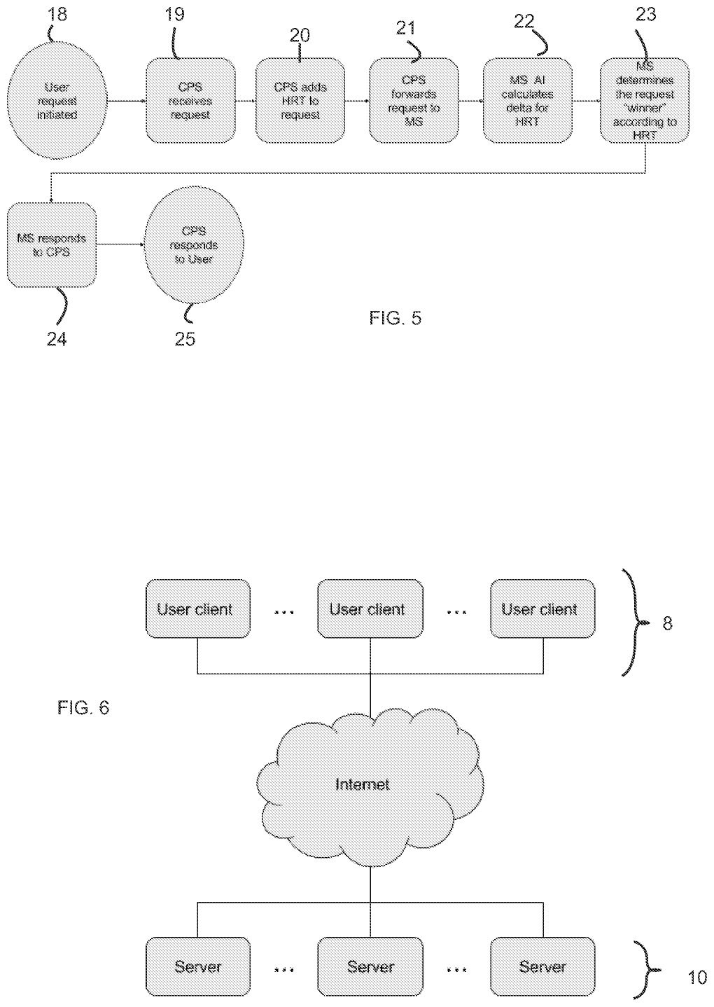

The servers would then be connected in a sequential manner as shown in FIG. 5. The requests 18 the service ie. click the button in this case. The CPC receives the request 19, and ads HRT to the request 20. Then the CPS forwards the request to the server 21 i.e the server application. The artificial intelligence (AI) of the server application calculates 22 delta for the HRT. The delta is a number of HRT units in order to achieve the fair time for the service, in this case for the game. Then the server application determines the request response “winner” 23. and sends 24 it to the CPS, which in turn sends 25 it to the user application.

These calculations and logic flows must be seen as examples of the final implementation. There may be other network and server parameters which will be utilized to fine tune and optimize the game performance and the end-user experience.

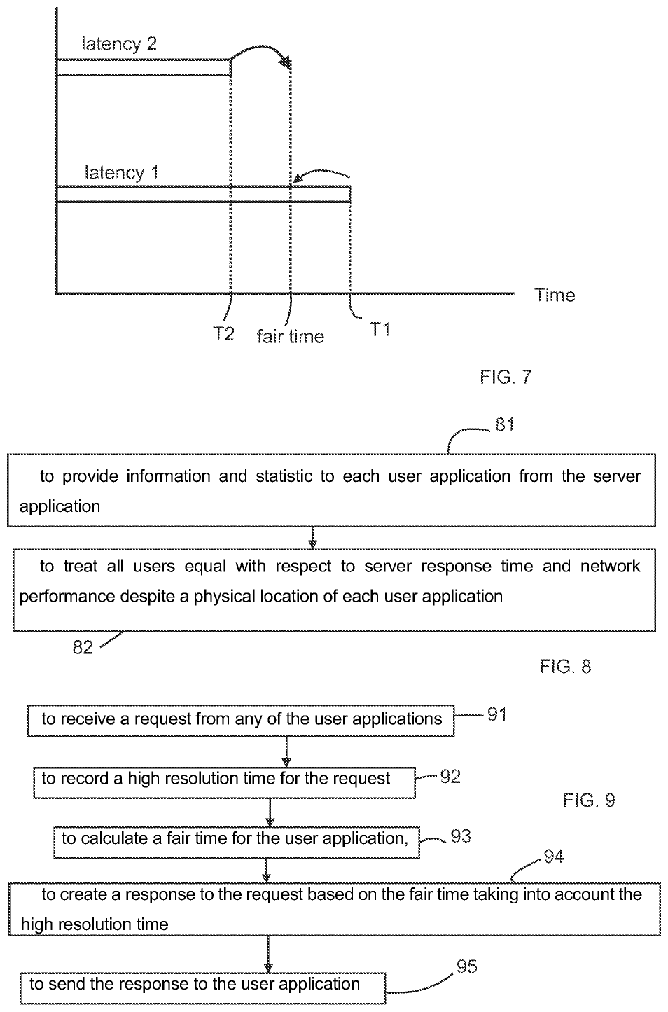

Scalable infrastructure is provided to ensure sufficient performance across all players with enhanced websocket communication layer (proprietary protocol for efficient transmission of data). The infrastructure (servers) is running online, using cloud services, on multiple geographical areas. The users are connecting to the servers globally over internet using their data connections. The application servers are scaled (for example horizontally scaled) up automatically depending on the number of user clients connected and CPU load of the application server, see FIG. 7.

FIG. 8 illustrates an example of the fair time and how it can be achieved. Let's think that a user of the service, like a game, has latency 1 in his communication connection. (in this example the latencies take into account other communication performances as well like bandwidth and service attacks.) The moment when the request from the user is received by the server is T1. Another user has, has latency 2 in his communication connection. Latency 2 in minor than the latency 1 so the request from the other user receives the server earlier, at moment T2, than the request of the first user. The server application has knowledge of all requests and communications for the service, and all receiving moments. In order to have an equal receiving time for every requests (like clicking the button) a virtual receiving time, called fair time, is calculated. The calculation of the fair time takes into account, distances of the connections, service attacks (DDos), latency and other possible parameters. The moment whereto the virtual receiving time is designed can be an average of the latencies of the connections.

In FIG. 8 the fair time, i.e. the virtual receiving time happens to be similar for the both connections, so the both requests are received with the same moment. However, in most cases there are differences between the calculated fair times for the connections/requests. D1 is time period, delta as said previously, to be decreased from T1 in order to receive the fair time. The calculation of D1 utilize HRT as smallest time unit to be calculated. Similarly, D2 is calculated for the other users request, but now D2 is added to T2. So in other words, equal treatment of users/players is accomplished by estimating the network delay of each user/player and calculating a fair time for each user/player by adding or subtracting a time difference with respect to the average network delay of all users/players. The fair time is then used to determine the temporal successive order of the clicks in the game/service.

The click math is using AI to determine which areas of the game need more rewards and which aren't, such as click rewards, active player rewards, special events and promotions, etc. The technological innovation for adapting the game user experience is that we provide gamified user experience for the player from time-to-time based on various data and information as well as also by doing split testing of e.g. new features/add-ons that will help user to get better user experience. Examples of such user experience are: allow user to use specific add-ons, provide special event or game mode depending on player behavior and history, test whether user clicks more happily the green or red button, etc.

The AI is determining these based on multiple unique technical factors and innovations by the inventors of the game, such as:
Factors and analysis on the user profile: location, country, language, age
Geographical analysis and gaming activity in those areas
User gaming behavior and history: aggressive player, active player passive player, random player
Generic gaming behavior and statistics: click strategy, click history, click frequency
And using other market integrations and online data, such as IP data information, Google search engine trends, social media feeds (e.g. public Twitter or Facebook and similar feeds), news feeds (e.g. RSS feeds, news sites, gaming sites)

A novel skill-based online game, ClickJackpot, has been described in this document. The implementation of the game includes multiple technical inventions which enhance and optimize the game functionality and user-experience. The game will evolve in subsequent release versions in which the user interface may be enriched with additional features. These features may include, for example, improved views of the game progress and statistics, team player versions, social sharing of game performance, storage and review functionalities of game sessions, bet multiplications and diversions, etc.

The algorithms running on the server and server network optimize the player experience by fusing data from multiple sources. These data sources will evolve in the future, as user profiles and online data becomes readily available in an ever-increasing manner. Over time, Artificial Intelligence algorithms will learn the players' performance and usage patterns and enhance the game experience even further. The Artificial Intelligence algorithms also detect if a player uses an automated clicking program (robot) trying to unfairly win the game. The response times of each player must adapt to the minimum reaction time of a human being.

The strategically placed server network will enable the fair-game logic described in this document. Every player has the same chance of winning regardless of the location and the connection speed or delay. The same technical implementation can further be used for creating other fair global trade deals e.g. in terms of stock exchange trading.

It is evident from the above that the invention is not limited to the embodiments described in this text but can be implemented in many other different embodiments within the scope of the independent claims.

1. A system for acting on an online service among several users, which system comprises an user application (8) for each user, a server application (10) and a database (12), characterised in that the system is configured to provide information and statistic to each user application from the server application, and which system has an arrangement to treat all users equal with respect to server response time and network performance despite a physical location of each user application.

2. A system according to claim 1, characterised in that the arrangement in the server application (10) is arranged to receive a request from any of the user applications (8), to record a high resolution time for the request, to calculate a fair time for the user application, to create a response to the request based on the fair time taking into account the high resolution time, and to send the response to the user application (8).

3. A system according to claim 2, characterised in that the calculation of the fair time takes into account a physical distance between the user application and the server application, global trends based on distributed denial of service attacks, and latency time between the user application (8) and the server application (10).

4. A system according to claim 3, characterised in that the latency time is based on a time of a day.

5. A system according to claim 4, characterised in that the latency time is further based on the day of a week.

6. A system according to any of claims 3-5, characterised in that said equal treatment of users is accomplished by estimating the network delay of each user and calculating said fair time for each user by adding or subtracting a time difference with respect to the average network delay of all users, said fair times being used to determine a temporal successive order of the requests in the service.

7. A system according to any of claims 3-6, characterised in that the system comprises at least one other server application (9), which other server application is between any of the user applications (8) and the server application (10), and arranged to record a high resolution time for the request of the user application, to forward the request containing the high resolution time to the server application, wherein the arrangement in the server is arranged to receive a request from any of the user applications (10) via the other server application (9), and
the calculation of the fair time takes into account a physical distance between the user application (8) and the other server application (10), a physical distance between the other server application and the server application, global trends based on distributed denial of service attacks between the user application and the other server application, global trends based on distributed denial of service attacks between the other server application and the server application, and latency time between the user application and the other server application, and the latency time between the other server application and the server application, and to send the response to the user application via the other server application.

8. A system according to claim 7, characterised in that the system comprises more than one server application (10), each server application to be located in separate servers, the arrangement being arranged to make a connection between one of the user application (8) and one of the server application (10) in such a way that a connection performance value is calculated to each server application and a average connection performance value, and the server application having the connection performance value closest to the average value is selected to be the server application for the connection.

9. A system according to claims 2-8, characterised in that the server application (10) comprises an adaptive artificial intelligence logic to provide said fair time calculation.

10. A system according to claim 9, characterised in that the artificial intelligence logic is arranged to detect an automated program that sends the requests.

11. A system according to claims 1-10, characterised in that it comprises at least one hot cache between the server application and the database.

12. A system according to claims 1-11, characterised in that the system is for playing an online game among said several users, the users being players of the online game, and the system is configured to provide information and statistic to each player to increase probability for winning the game, and which system has an arrangement to treat all players equal with respect to server response time and network performance despite a physical location of each player.

13. A system according to claim 12, characterised in that the user application is in a user device, and is arranged to provide said information and statistic, a number of requests of the online game and a request button on a display of the user device.

14. A method for acting on an online service among several users, which service utilizes an user application for each user, a server application and a database, characterised in that the method comprises steps to provide (81) information and statistic to each user application from the server application, and to treat (82) all users equal with respect to server response time and network performance despite a physical location of each user application.

15. A method according to claim 14, characterised in that it comprises steps to be run in the server application, which steps comprise a step to receive (91) a request from any of the user applications, a step to record (92) a high resolution time for the request, a step to calculate (93) a fair time for the user application, a step to create (94) a response to the request based on the fair time taking into account the high resolution time, and a step to send (95) the response to the user application.

16. A method according to claim 15, characterised in that the calculation step of the fair time takes into account a physical distance between the user application and the server application, global trends based on distributed denial of service attacks, and latency time between the user application and the server application.

17. A method according to claim 16, characterised in that the latency time is based on a time of a day.

18. A method according to claim 17, characterised in that the latency time is further based on the day of a week.

19. A system according to any of claims 3-5, characterised in that said equal treatment of users is accomplished by estimating the network delay of each user and calculating said fair time for each user by adding or subtracting a time difference with respect to an average network delay of all users, said fair times being used to determine a temporal successive order of the requests in the service.

20. A method according to any of claims 16-18, characterised in that the service further utilizes at least one other server application, which other server application is between any of the user applications and the server application, and the method is arranged to record a high resolution time for the request of the user application in said other server application, to forward the request containing the high resolution time to the server application, wherein the method is arranged to receive a request from any of the user applications via the other server application, and in which method the calculation of the fair time takes into account a physical distance between the user application and the other server application, a physical distance between the other server application and the server application, global trends based on distributed denial of service attacks between the user application and the other server application, global trends based on distributed denial of service attacks between the other server application and the server application, and latency time between the user application and the other server application, and the latency time between the other server application and the server application, and which method is arranged to send the response to the user application via the other server application.

21. A method according to claim 19, characterised in that the method is arranged to make a connection between one of the user application and one of the server application in such a way that a connection performance value is calculated to each server application and an average connection performance value, and the server application having the connection performance value closest to the average value is selected to be the server application for the connection.

22. A system according to claim 20, characterised in that the method is arranged to detect an automated program that sends the requests.

23. A system according to claims 14-21, characterised in that the method is for playing an online game among said several users, the users being players of the online game, and the system is configured to provide information and statistic to each player to increase probability for winning the game, and which system has an arrangement to treat all players equal with respect to server response time and network performance despite a physical location of each player.

24. A system according to claim 22, characterised in that the method is arranged to provide said information and statistic, a number of requests of the online game and a request button on a display of a user device.
